(19) United States
(12) Patent Application Publication
(10) Pub. No.: US 2014/0308609 A1
(43) Pub. Date: Oct. 16, 2014

(54) POSITIVELY CHARGEABLE TONER FOR NONMAGNETIC MONO-COMPONENT DEVELOPMENT SYSTEM

(71) Applicant: MITSUBISHI CHEMICAL CORPORATION, Tokyo (JP)

(72) Inventor: Kenichi NAKAZATO, Niigata (JP)

(73) Assignee: MITSUBISHI CHEMICAL CORPORATION, Tokyo (JP)

(21) Appl. No.: 14/316,420

(22) Filed: Jun. 26, 2014

Related U.S. Application Data
(63) Continuation of application No. PCT/JP2012/082974, filed on Dec. 19, 2012.

(30) Foreign Application Priority Data
Dec. 26, 2011 (JP) 2011-283696

(51) Int. Cl. G03G 9/08; G03G 9/087; G03G 9/09

(52) U.S. Cl. CPC G03G 9/0825; G03G 9/0904; G03G 9/08733
USPC 430/108.11

(57) ABSTRACT

The invention addresses the problem of providing a positively chargeable toner for nonmagnetic mono-component development systems, which is free from image density reduction, back ground and toner scattering inside the machine that are caused by insufficient electrification and which has excellent toner starvation on black page, without impairing the durability. In the positively chargeable toner for nonmagnetic mono-component development system, which at least comprises a binder resin, a colorant and a charge control agent, a styrene-acrylic resin is used as the binder resin, and the toner comprises: polytetrafluoroethylene fine particles; and inorganic fine particles that have been surface-treated with an amino group-containing treating agent.

### TECHNICAL FIELD

The present invention relates to a toner for development of electrostatic images and an image formation method that are used in electrophotography, electrostatic recording, etc.

### BACKGROUND ART

The toner particles for use in the toner for development of electrostatic images that have heretofore been generally widely used are produced according to a dry method of a melt-kneading grinding method or the like or to a wet method of suspension polymerization or the like. Subsequently, the resulting toner particles are optionally processed in post-steps of an external additive adding step of adding thereto an external additive and the like to give a toner for development of electrostatic images (hereinafter this may be simply abbreviated as “toner”).

Heretofore, as a development system to be employed in electrophotography or the like, there are known a two-component development system using a developer that comprises a magnetic carrier and a toner, and a mono-component development system not using a magnetic carrier, etc. The mono-component development system is further broadly divided into a magnetic mono-component development system and a nonmagnetic mono-component development system.

JP-A 9-127727 (PTL 1) reports that, for providing a positively chargeable toner which, even when an organic photoreceptor is used, fogs little the photoreceptor and which can enhance the durability of the photoreceptor, a polyester resin having a specific acid value is used for the binder resin of the toner and further polytetrafluoroethylene having a specific particle size is added to the surface of the toner particles and, as a result, a toner for nonmagnetic mono-component development systems, which is free from photoreceptor fogging and which is excellent in low-temperature fixation and durability, can be thereby obtained.

JP-A 2003-114548 (PTL 2) found the problem of the toner for nonmagnetic mono-component development systems disclosed in JP-A 9-127727 that deposits often adhere to developing blades, and reports that, in addition to using a polyester resin as the binder resin and using polytetrafluoroethylene as the external additive, when a specific quaternary ammonium base-containing copolymer is incorporated in the toner as a charge controlling resin therein and when the toner surface is coated with negatively chargeable organic fine particles and inorganic particles, then the formation of deposits adhering to development blades can be reduced while retaining the toner performance.

### CITATION LIST

### Patent Literature

PTL 1: JP-A 9-127727

PTL 2: JP-A 2003-114548

### SUMMARY OF INVENTION

### Technical Problem

However, it has been found that the above-reported toner for nonmagnetic mono-component development systems could not sufficiently attain a suitable electrification amount and therefore has some problems of image density reduction, back ground, etc.

The present invention addresses, in a nonmagnetic mono-component development system, the problem of providing a positively chargeable toner for nonmagnetic mono-component development systems which is free from image density reduction, back ground and toner scattering inside the machine, which are caused by insufficient electrification, and which has excellent toner starvation on black page, without impairing the durability.

### Solution to Problem

As a result of assiduous investigations, the present inventors have found that, in a positively chargeable toner for nonmagnetic mono-component development system, which at least comprises a binder resin, a colorant and a charge control agent, when a styrene-acrylic resin is used as the binder resin and when polytetrafluoroethylene fine particles and inorganic fine particles that have been surface-treated with an amino group-containing treating agent are added to the surface of the toner particles, then the above-mentioned problems can be solved, and have reached the present invention.

Specifically, the gist of the invention resides in the following <1> to <6>.
<1> A positively chargeable toner for nonmagnetic mono-component development system, which at least comprises a binder resin, a colorant and a charge control agent wherein the binder resin is a styrene-acrylic resin, and the toner at least comprises: polytetrafluoroethylene fine particles: and inorganic fine particles that have been surface-treated with an amino group-containing treating agent.
<2> The positively chargeable toner for nonmagnetic mono-component development system according to the item <1> above, wherein the colorant is carbon black satisfying the following (1) and (2):

(1) The mean primary particle size is from 20 nm to 50 nm,

(2) The DBP oil absorption is from 100 cc/100 g to 200 cc/100 g.
<3> The positively chargeable toner for nonmagnetic mono-component development system according to the item <1> or <2> above, which comprises electroconductive fine particles having a resistance of from 1 Ω·cm or more to 100 Ω·cm or less.
<4> The positively chargeable toner for nonmagnetic mono-component development system according to the item <3> above, wherein the electromagnetic fine particles are an electroconductive titanium oxide.
<5> The positively chargeable toner for nonmagnetic mono-component development system according to any one of the items <1> to <4> above, wherein the inorganic fine particles that have been surface-treated with an amino group-containing treating agent contain inorganic fine particles A that have been surface-treated with an amino group-containing treating agent and inorganic fine particles B that have been surface-treated with an amino group-containing treating agent, and the inorganic fine particles satisfy the following formula (I):

aᵣ/bᵣ<1 Formula (I)

(In the above formula (I), aᵣ (nm) represents the mean primary particle size (nm) of the inorganic fine particles A that have been surface-treated with an amino group-containing treating agent; and bᵣ (nm) represents the mean primary particle size (nm) of the inorganic fine particles B that have been surface-treated with an amino group-containing treating agent.)
<6> The positively chargeable toner for nonmagnetic mono-component development systems according to any one of the items <1> to <5> above, wherein the inorganic fine particles that have been surface-treated with an amino group-containing treating agent contain inorganic fine particles A that have been surface-treated with an amino group-containing treating agent and inorganic fine particles B that have been surface-treated with an amino group-containing treating agent, and the inorganic fine particles satisfy the following formula (II):

aₘ/bₘ≦1 Formula (II)

(In the above formula (II), aₘ (part by mass) represents the amount of the inorganic fine particles A that have been surface-treated with an amino group-containing treating agent in terms of part by mass relative to 100 parts by mass of the toner particles; and bₘ (part by mass) represents the amount of the inorganic fine particles B that have been surface-treated with an amino group-containing treating agent in terms of part by mass relative to 100 parts by mass of the toner particles.)

### Advantageous Effects of Invention

According to the invention, there is provided a positively chargeable toner for nonmagnetic mono-component development systems, which can obtain a sufficient electrification amount and is therefore free from image density reduction, back ground and toner scattering inside the machine that are caused by insufficient electrification and which has excellent toner starvation on black page.

### DESCRIPTION OF EMBODIMENTS

The invention is described in detail hereinunder; however, the invention is not limited to the following embodiments but can be carried out in any other modification within the range not overstepping the scope and the spirit of the invention. In this description, “mass” means “weight”.

The positively chargeable toner for nonmagnetic mono-component development systems of the invention contains at least a styrene-acrylic binder resin, a colorant and a charge control agent and contains polytetrafluoroethylene fine particles and inorganic fine particles that have been surface-treated with an amino group-containing treating agent, and if desired, any other external additives, wax as well as still other additives may be suitably selected and added thereto. The toner may be obtained through a step of producing toner particles and an external additive-adding step of adding to the surface of the toner particles, polyfluoroethylene fine particles and inorganic fine particles that have been surface-treated with an amino group-containing treating agent.

In the invention, the method for producing the toner before adding polytetrafluoroethylene fine particles and other external additives to the surface of the toner particles, or that is, the toner matrix particles (this may be referred to as toner particles) is not specifically defined, for which there are mentioned various production methods including a grinding method of a melt-kneading grinding method or the like as well as a wet method of a suspension polymerization method, an emulsion polymerization flocculation method, a dissolution suspension method or the like.

The melt-kneading grinding method is a method of obtaining toner matrix particles by dry-mixing a binder resin, a colorant and optionally a charge control agent, a mold release agent, a magnetic substance and others, then melt-kneading the resulting mixture through an extruder or the like, and thereafter grinding and classifying it.

The suspension polymerization method is a method of obtaining toner matrix particles, which comprises suspending and dispersing a composition comprising components of a polymerizable monomer, a polymerization initiator, a colorant and others in an aqueous medium and then polymerizing them to give particles, and thereafter washing and drying the particles.

The emulsion polymerization flocculation method is a method of obtaining toner matrix particles, which comprises emulsifying a polymerizable monomer in an aqueous medium containing a polymerization initiator and an emulsifier, polymerizing the polymerizable monomer with stirring to give polymer primary particles, then adding thereto a colorant and optionally a charge control agent to flocculate the polymer primary particles, further ripening the resulting flocculate particles, and washing and drying the particles.

The dissolution suspension method is a method of obtaining toner matrix particles, which comprises dispersing a solution phase that has been prepared by dissolving a binder resin in an organic solvent and adding and dispersing therein a colorant and others, in an aqueous phase containing a dispersant or the like, mechanically with shear force to form liquid droplets, then removing the organic solvent from the liquid droplets to give particles, and washing and drying the particles.

### <Binder Resin>

The toner of the invention contains at least a styrene-acrylic resin as the constituent binder resin therein. In the toner of the invention, the binder resin may be a styrene-acrylic resin alone, or may be a combination of the resin with any other optional resin. The optional resin includes, for example, vinylic resin, rosin-modified maleic acid resin, phenolic resin, epoxy resin, saturated or unsaturated polyester resin, polyethylenic resin, polypropylenic resin, ionomer resin, polyurethane resin, silicone resin, ketone resin, ethylene-acrylate copolymer, xylene resin, polyvinyl butyral resin, styrene-alkyl acrylate copolymer, styrene-alkyl methacrylate copolymer, styrene-acrylonitrile copolymer, styrene-butadiene copolymer, styrene-maleic acid copolymer, etc.

In the toner of the invention, the content of the styrene-acrylic resin in the binder resin is generally 50% by mass or more, and from the viewpoint of fixation and durability, the content is preferably 70% by mass or more, more preferably 90% by mass or more, even more preferably 95% by mass or more.

Further, in the invention, a crosslinking agent may be used in producing the binder resin for increasing the mechanical strength of the toner particles.

The starting material, polymerizable monomer for use in producing the binder resin in the invention is not specifically defined. Concretely, for example, there are mentioned styrene; styrene derivatives such as p-methylstyrene, α-methylstyrene, chlorostyrene, dicholorostyrene, etc.; (meth)acrylates; (meth)acrylic acid; (meth)acrylamide; (meth)acrylamide derivatives such as N-alkyl(meth)acrylamides, N,N-dialkyl(meth)acrylamides, etc.; vinyl compounds such as vinyl chloride, vinyl acetate, etc.; maleic anhydride; acrylonitrile; alkene compounds such as propylene, butadiene, etc. Here the expression of “(meth)acryl” means “acryl” and/or “methacryl”, and the same shall apply hereunder. Styrene and/or styrene derivatives may be simply abbreviated as “styrene (derivatives)”.

Of the above, as (meth)acrylates, preferred are methyl(meth)acrylate, ethyl(meth)acrylate, butyl(meth)acrylate, pentyl(meth)acrylate, heptyl(meth)acrylate, octyl(meth)acrylate, phenyl(meth)acrylate, hydroxyethyl(meth)acrylate, etc.; and more preferred is n-butyl acrylate. One alone or two or more these polymerizable monomers may be used here either singly or as combined.

As the binder resin in the invention, preferred is a (co)polymer of the above-mentioned polymerizable monomer; and more preferred are a copolymer containing a styrene (derivative) and a (meth)acrylate, and a copolymer containing a styrene (derivative), a (meth)acrylate and a (meth)acrylic acid.

For crosslinking the polymerizable monomer, usable here is a polyfunctional monomer. The polyfunctional monomer includes, for example, divinylbenzene; di(meth)acrylates such as hexanediol di(meth)acrylate, ethylene glycol di(meth)acrylate, triethylene glycol di(meth)acrylate, neopentyl glycol di(meth)acrylate, etc.; diallyl phthalate, etc. As the polymerizable monomer to be crosslinked, further sable here is a polymerizable monomer having a reactive group as a pendant therein, for example, glycidyl (meth)acrylate, methylol (meth)acrylamide, acrolein, etc. One alone or two or more of these may be used here either singly or as combined.

Above all, for favorably crosslinking the binder resin, preferred is a radical-polymerizable difunctional monomer, and more preferred is divinylbenzene, hexanediol di(meth)acrylate, or the like.

In the invention, if desired, any known polymerization initiator may be used. One or more different types of polymerization initiators may be used either singly or as combined. For example, usable here are persulfates such as potassium persulfate, sodium persulfate, ammonium persulfate, etc.; redox initiators comprising the persulfate as one component as combined with a reducing agent such as acidic sodium sulfite, etc.; water-soluble polymerization initiators such as hydrogen peroxide, 4,4′-azobiscyanovaleric acid, t-butyl hydroperoxide, cumene hydroperoxide, etc.; redox initiators comprising the water-soluble polymerization initiator as one component as combined with a reducing agent such as ferrous salt, etc.; benzoyl peroxide, 2,2′-azobisisobutyronitrile, etc. The polymerization initiator may be added to the polymerization system in any stage before, during or after monomer addition, and if desired, the addition methods may be combined.

The amount of the polymerization initiator to be added may vary depending on the intended degree of polymerization, but is preferably from 0.1 parts by mass or more to 20 parts by mass or less relative to 100 parts by mass of the polymerizable monomer.

Further in the invention, any known suspension stabilizer may be used, if desired. Specific examples of the suspension stabilizer include calcium phosphate, magnesium phosphate, calcium hydroxide, magnesium hydroxide, etc. One alone or two or more of these may be used here either singly or as combined. The stabilizer may be used in an amount of 1 part by mass or more and 10 parts by mass or less relative to 100 parts by mass of the polymerizable monomer.

The polymerization initiator and the suspension stabilizer may be added to the polymerization system in any stage before, during or after addition of the polymerizable monomer, and if desired, the addition methods may be combined.

In the invention, a dispersion stabilizer may be used, if desired in dispersing the polymerizable monomer in the aqueous medium. One alone or two or more different types of known dispersion stabilizers may be used either singly or as combined in the invention.

For example, there are mentioned inorganic oxides including tricalcium phosphate, magnesium phosphate, aluminium phosphate, zinc phosphate, calcium carbonate, magnesium carbonate, calcium hydroxide, magnesium hydroxide, aluminium hydroxide, calcium metasilicate, calcium sulfate, barium sulfate, bentonite, silica, alumina, titania, etc. Also mentioned are organic compounds including, for example, polyvinyl alcohol, gelatin, methyl cellulose, methylhydroxypropyl cellulose, ethyl cellulose, carboxymethyl cellulose sodium salt, starch, etc. Preferably, the dispersion stabilizer is used in an amount of 0.2 parts by mass or more and 10 parts by mass or less relative to 100 parts by mass of the polymerizable monomer.

### <Colorant>

As the colorant in the invention, usable is any one suitably selected from those known as usable for toner. Specific examples of the colorant include carbon black, aniline blue, phthalocyanine blue, phthalocyanine green, Hansa yellow, rhodamine dye and pigment, chromium yellow, quinacridone, benzidine yellow, rose Bengal, triallylmethane dye, monoazo dye and pigment, disazo dye and pigment, condensed azo dye and pigment, etc.; and any such known dyes and pigments may be used here either singly or as combined. In case of full color toner, it is desirable that benzidine yellow, monoazo dye or pigment or condensed azo dye or pigment is used for yellow, quinacridone or monoazo dye or pigment is used for magenta, and phthalocyanine blue is used as cyan.

Of the above, when carbon black is used here, it may exist as aggregates of extremely fine primary particles, and when it is dispersed as a pigment dispersant, the particles may tend to reaggregate to give coarse particles. The degree of reaggregation of carbon black particles is often correlated to the level of the amount of the impurities contained in carbon black (the level of the amount of undecomposed organic substances remaining therein); and when the amount of the impurities is large, then the particles would greatly reaggregate to give coarse particles after dispersion. For quantitative determination of the amount of impurities, there is generally known a method of measuring the UV absorbance of the toluene extract of carbon black. In general, carbon black prepared in a channel process tends to have a large amount of impurities, and therefore when carbon black is used in the invention, preferred is carbon black prepared according to a furnace process.

In the invention, when carbon black is used as the colorant, the mean primary particle size of the carbon black is generally 20 nm or less as the lower limit, and from the viewpoint of having excellent dispersibility in toner and of imparting suitable electroconductivity to toner, the mean primary particle size is preferably 25 nm or more, more preferably 30 nm or more. On the other hand, the upper limit is generally 80 nm or less, and from the viewpoint of imparting suitable electroconductivity to toner, the upper limit is preferably 50 nm or less, more preferably 40 nm or less, even more preferably 35 nm or less. When the mean primary particle size of carbon black is too small, then the electroconductivity would increase too much and if so, the toner could not obtain a suitable electrification amount. On the other hand, when the mean primary particle size is too large, then the electroconductivity would be too low and if so, the toner could not also obtain a suitable electrification amount.

The DBP oil absorption of carbon black is generally 50 cc/100 g or more as the lower limit, and from the viewpoint of imparting suitable electroconductivity to toner, the oil absorption is preferably 70 cc/100 g or more, more preferably 100 cc/100 g or more, even more preferably 120 cc/100 g or more. On the other hand, the upper limit is generally 220 cc/100 g or less, and from the viewpoint of imparting suitable electroconductivity to toner, the upper limit is preferably 210 cc/100 g or less, more preferably 200 cc/100 g or less, even more preferably 190 cc/100 g or less. When the DBP oil absorption of carbon black is too low, then the electroconductivity would be too low and if so, the toner could not obtain a suitable electrification amount. On the other hand, when the oil absorption is too large, then the electroconductivity would increase too which and if so, the toner could not also obtain a suitable electrification amount.

In the invention, when carbon black is used and is controlled to fall within the above range from the viewpoint of the dispersibility of carbon black in toner and of the electroconductivity to be given to toner, then various harmful results of unevenness in toner electrification amount distribution on developing sleeves, back ground and toner scattering inside the machine could be favorably prevented.

### <Charge Control Agent>

When a charge control agent is used in the invention, any known ones may be used either singly or as combined. In particular, especially preferred for use herein is a charge control agent that secures a high electrification speed and can stably maintain a constant electrification amount. Further, when toner particles are directly produced according to a polymerization method, preferred is use of a charge control agent not having any negative influence on polymerization and not leaving any soluble matter in the aqueous dispersion medium. Concretely, as positive charge control agents, there are mentioned quaternary ammonium salts; polymer compounds having a quaternary ammonium salt in the side chain; guanidine compounds; imidazole compounds; compounds having an azine skeleton, etc. If desired, a charge control resin prepared by grafting the above-mentioned compound in resin is also usable here.

The amount of the charge control agent may be determined depending on the desired electrification amount of toner. In general, the amount is 0.01 pars by mass or more relative to 100 parts by mass of the polymer primary particles, and is preferably 0.1 parts by mass or more. In general, the amount is 10 parts by mass or less, preferably 5 parts by mass or less. When a wet polymerization method is employed here, it is desirable that the volume median diameter (Mv50) of the charge control agent in water is 0.01 μm or more, more preferably 0.05 μm or more. Also preferably, the volume median diameter is 3 μm or less, and preferred is use of a fine dispersion of 1 μm or less.

### <Wax>

In the invention, wax may be used optionally. Wax that may be used in the invention may be any one falling within a range not detracting from the advantageous effects of the invention. Concretely mentioned are the following: Petroleum wax and its derivatives such as paraffin wax, microcrystalline wax, petrolatum; montan wax and its derivatives; hydrocarbon wax and its derivatives according to a Fischer-Tropsch method; polyolefin wax and its derivatives such as polyethylene, polypropylene; natural wax and its derivatives such as carnauba wax, candelilla wax (derivatives include oxides, block copolymers with vinylic monomer, graft-modified derivatives); higher aliphatic alcohols; fatty acids such as stearic acid, palmitic acid, etc.; acid amide wax, ester wax, ketone, hardened castor oil and its derivatives, vegetable wax, animal wax, silicone wax. One or more of these waxes may be used here either singly or as combined.

In case where wax is used in the invention, the amount of wax to be used is not specifically defined so far as it falls within a range not detracting from the advantageous effects of the invention. In general, the lower limit is 1 part by mass or more in 100 parts by mass of toner, preferably 2 parts by mass or more, more preferably 3 parts by mass or more. On the other hand, the upper limit is generally 40 parts by mass or less, preferably 35 parts by mass or less, more preferably 30 parts by mass or less. When the amount of the wax in the toner is too small, then the performance of the toner such as high-temperature offset property thereof would be insufficient; but when too large, then the blocking resistance of toner would be insufficient or wax would bleed out of the toner to stain apparatuses.

### <External Additive>

The following external additive to be used in the invention and any other external additive optionally used here are described in detail.

### [1. Polytetrafluoroethylene Fine Particles]

In the invention, polytetrafluoroethylene fine particles are used and added to the surface of the toner particles. The mean primary particle size of the polytetrafluoroethylene fine particles is not specifically defined. The lower limit of the particle size is generally 0.01 μm, and from the viewpoint of preventing the fine particles from being buried in the toner particles in continuous printing, the particle size is preferably 0.05 μm or more, more preferably 0.1 μm or more, even more preferably 0.15 μm or more. On the other hand, the upper limit is generally 0.5 μm or less, and from the viewpoint of preventing the fine particles from releasing from the toner particles, it is preferably 0.45 μm or less, more preferably 0.4 μm or less. When the mean primary particle size of the polytetrafluoroethylene fine particles is too small, then the fine particles would be buried in the toner particles; but when too large, the fine particles would separate from the toner particles, and as a result, the invention could not secure the advantageous effects thereof. Here the mean particle size of the primary particles of the fine particles is determined by averaging the numerical data of the particle size of the primary particles on the electromicroscopic photograph of the particles.

Polytetrafluoroethylene fine particles of the type include, for example, “KTL-500F” (by Kitamura, mean particle size of primary particles 0.3 μm), “Lublon L2” (by Daikin Industry, mean particle size of primary particles 0.3 μm), “Lublon L5” (by Daikin Industry, mean particle size of primary particles 0.2 μm), “Fluon Lubricant L170J” (by Asahi ICI Fluoropolymers, mean particle size of primary particles 0.1 μm), “Fluon Lubricant L172J” (by Asahi ICI Fluoropolymers, mean particle size of primary particles 0.1 μm), “MP-1100” (by Mitsui DuPont Fluorochemical, mean particle size of primary particles 0.2 μm), “MP-1200” (by Mitsui DuPont Fluorochemical, mean particle size of primary particles 0.3 μm), “TLP-10E-1” (by Mitsui DuPont Fluorochemical, mean particle size of primary particles 0.2 μm), “Fluoro A” (by Shamrock, mean particle size of primary particles 0.3 μm), etc.

The amount of the polytetrafluoroethylene fine particles to be added is not specifically defined so far as the amount does not detract from the advantageous effects of the invention. In general, the lower limit of the amount is 0.01 parts by mass or more relative to 100 parts by mass of the toner particles, preferably 0.05 parts by mass or more. On the other hand, the upper limit is generally 1.5 parts by mass, preferably 1.0 part by mass. When the amount is larger than the range, then the toner flowability and transferability would be lower than the suitable level thereof and, if so, the image density may lower. However, when the amount is smaller than the range, then the toner flowability and transferability would be higher than the suitable level thereof and, if so, image fogging and photoreceptor fogging would increase.

[2. Inorganic Fine Particles Surface-Treated with Amino Group-Containing Compound]

In the invention, from the viewpoint of imparting positive chargeability to toner and maintaining the toner flowability, inorganic fine particles that have been surface-treated with an amino group-containing treating agent are added to the surface of the toner particles. As the inorganic fine particles to be surface-treated, there are mentioned various oxides such as calcium oxide, magnesium oxide, zinc oxide, copper oxide, aluminium oxide, cerium oxide, silica, titania, etc.; various titanate compounds such as calcium titanate, magnesium titanate, strontium titanate, etc.; phosphate compounds such as calcium phosphate, etc.; sulfides such as molybdenum disulfide, etc.; fluorides such as magnesium fluoride, carbon fluoride, etc.; magnetite, ferrite, etc. Of those, from the viewpoint of preventing the inorganic fine particles from being buried and of maintaining the toner flowability, preferred is use of silica having a small specific gravity. In the invention, in case where silica is used as the inorganic fine particles to be surface-treated, preferred is use of hydrophobic silica that has been hydrophobized from the viewpoint of the environmental stability thereof.

In the invention, the mean primary particle size of the inorganic fine particles that have been surface-treated with an amino group-containing treating agent is not specifically defined so far as it falls within a range not detracting from the advantageous effects of the invention, and in general, the lower limit thereof is 1 nm or more, preferably 5 nm or more, while on the other hand, the upper limit thereof is generally 100 nm or less, preferably 80 nm or less, more preferably 50 nm or less.

Specific examples of the inorganic fine particles that have been surface-treated with an amino group-containing treating agent include “TG-820F” and “TG7120” (by Cabot), “H30TA” and “H13TA” (by Wacker), “MSP-11”, and “MSP-9” (by Tayca), “R504”, “RA200HS” and “NA50H” (by Nippon Aerosil), etc.

The amount to be added of the inorganic fine particles that have been surface-treated with an amino group-containing treating agent is not specifically defined so far as it falls within a range not detracting from the advantageous effects of the invention, and relative to 100 parts by mass of the toner particles, the lower limit thereof is generally 0.01 parts by mass or more, preferably 0.05 parts by mass or more, more preferably 0.1 parts by mass or more, while on the other hand, the upper limit thereof is generally 5.0 parts by mass or less, preferably 2.0 parts by mass or less, more preferably 1.0 part by mass or less. When the amount added is larger than the range, then the toner flowability and transferability would be lower than the suitable level thereof and, if so, the image density may lower. However, when the amount is smaller than the range, then the toner flowability and transferability would be insufficient so that the image density would lower and the toner conformability to solid image would be poor.

In the invention, the inorganic fine particles that have been surface-treated with an amino group-containing treating agent are not specifically defined so far as the inorganic fine particles that have been surface-treated with the above-mentioned amino group-containing treating agent are used; however, from the viewpoint of maintaining the toner flowability and durability, it is desirable that the toner contains at least two types of inorganic fine particles which have been surface-treated with the amino group-containing treating agent and which differ in point of the mean primary particle size thereof. In a nonmagnetic mono-component development system, the toner is given a pressure while passing through the developing sleeve and the control blade for controlling the toner amount so that the toner is thereby given a relative stress. Accordingly, from the viewpoint of the durability thereof, the toner must fully secure the flowability thereof even when given a stress, and in this case, when the toner contains at least two types of inorganic fine particles which have been surface-treated with the amino group-containing treating agent and which differ in point of the mean primary particle size thereof, then the toner can sufficiently secure the toner durability and flowability.

In case where the inorganic fine particles which have been surface-treated with the amino group-containing treating agent are at least two types of inorganic fine particles which have been surface-treated with the amino group-containing treating agent and which differ in point of the mean primary particle size thereof, and when the two types of inorganic fine particles which have been surface-treated with the amino group-containing treating agent are referred to as A and B, it is desirable that the inorganic fine particles A which have been surface-treated with the amino group-containing treating agent and the inorganic fine particles B which have been surface-treated with the amino group-containing treating agent satisfy the following formula (I):

aᵣ/bᵣ<1 Formula (I)

In the above formula (I), aᵣ (nm) represents the mean primary particle size (nm) of the inorganic fine particles A that have been surface-treated with the amino group-containing treating agent; and bᵣ (nm) represents the mean primary particle size (nm) of the inorganic fine particles B that have been surface-treated with the amino group-containing treating agent.

aᵣ/bᵣ is generally less than 1, and from the viewpoint of toner starvation on black page, the ratio is preferably 0.8 or less, but from the viewpoint of preventing the inorganic fine particles A having a relatively small particle size from being buried in the toner to lower the toner durability and from the viewpoint of securing the ability of the inorganic fine particles A having a relatively small particle size to provide the toner flowability, the ratio is more preferably 0.6 or less, even more preferably 0.4 or less, still more preferably 0.3 or less. aᵣ/bᵣ is larger than 0.

The mean primary particle size of the inorganic fine particles A and B that have been surface-treated with the amino group-containing treating agent is not specifically defined so far as the inorganic fine particles A that have been surface-treated with the amino group-containing treating agent are relatively smaller than the inorganic fine particles B that have been surface-treated with the amino group-containing treating agent, but in general, the mean particle size of the inorganic fine particles A that have been surface-treated with the amino group-containing treating agent is from 5 nm to 25 nm, and the mean particle size of the inorganic fine particles B that have been surface-treated with the amino group-containing treating agent is from 15 nm to 50 nm.

Also preferably, the inorganic fine particles A that have been surface-treated with the amino group-containing treating agent and the inorganic fine particles B that have been surface-treated with the amino group-containing treating agent satisfy the following formula (II):

aₘ/bₘ≦1 Formula (II)

In the above formula (II), aₘ (part by mass) represents the amount of the inorganic fine particles A that have been surface-treated with the amino group-containing treating agent in terms of part by mass relative to 100 parts by mass of the toner particles; and bₘ (part by mass) represents the amount of the inorganic fine particles B that have been surface-treated with the amino group-containing treating agent in terms of part by mass relative to 100 parts by mass of the toner particles.

aₘ/bₘ≦ is generally 1 or less, but from the viewpoint of the toner consumption amount and from the viewpoint of preventing the inorganic fine particles A having a relatively small particle size from being buried in the toner to lower the toner durability, the ratio is more preferably 0.5 or less, even more preferably 0.4 or less, still more preferably 0.3 or less. aₘ/bₘ is larger than 0.

The amount of the inorganic fine particles A and B that have been surface-treated with the amino group-containing treating agent in terms of part by mass relative to 100 parts by mass of the toner particles is not specifically defined so far as the amount of the inorganic fine particles A that have been surface-treated with the amino group-containing treating agent is relatively smaller than the amount of the inorganic fine particles B that have been surface-treated with the amino group-containing treating agent, but in general, the amount of the inorganic fine particles A that have been surface-treated with the amino group-containing treating agent is from 0.01 parts by mass or more and 5.0 parts by mass or less, and the amount of the inorganic fine particles B that have been surface-treated with the amino group-containing treating agent is 0.01 parts by mass or more and 5.0 parts by mass or less.

[3. Electro conductive Fine Particles]

In the invention, from the viewpoint of making the toner given a suitable electrification amount and of preventing the toner from flying, if desire, electroconductive fine particles may be added to the toner as an external additive thereto. The resistance of the electroconductive fine particles is not specifically defined so far as it falls within a range not detracting from the advantageous effects of the invention, but in general, the resistance is 1 Ω·cm or more, preferably 10 Ω·cm or more, more preferably 20 Ω·cm or more. On the other hand, the upper limit is generally 100 Ω·cm or less, preferably 80 Ω·cm or less, more preferably 70 Ω·cm or less, even more preferably 60Ω·cm or less. As the electroconductive fine particles, there are concretely mentioned metal oxides such as titania, silica, magnetite, etc.; inorganic fine particles prepared by doping the metal oxides with an electroconductive substance; organic fine particles prepared by doping a polymer having a conjugated double bond such as polyacetylene, polyphenylacetylene, poly-p-phenylene or the like, with an electroconductive substance such as metal or the like; carbon such as typically carbon black and graphite, etc. From the viewpoint of the property thereof that may provide clectroconductivity without detracting from the flowability of toner, preferred are titanium oxide and those prepared by doping titanium oxide with an electroconductive substance. Regarding the crystal structure thereof, titanium oxide may be any of a rutile-type one or an anatase-type one, or may also be in the form of a mixed crystal of a rutile-type one and an anatase-type one. In case where the electroconductive fine particles are used, those prepared by optionally hydrophobizing the particles may be used here.

For making inorganic or organic fine particles electroconductive by doping, a tin oxide layer may be formed on the surface of inorganic or organic fine particles, or inorganic or organic fine particles may be modified into eutectics with tin oxide, or the surface of inorganic or organic fine particles may be doped with antimony to thereby control the electroconductivity of the resulting particles. Preferably, an electroconductive layer of antimony-doped tin oxide is formed on the surface of inorganic or organic fine particles, and more preferably, an electroconductive layer of antimony-doped tin oxide is formed on the surface of titanium oxide.

The BET specific surface area of the electroconductive fine particles is not specifically defined so far as it falls within a range not detracting from the advantageous effects of the invention, but in general, it is 3 m²/g or more, preferably 4 m²/g or more, more preferably 5 m²/g or more. Also in general, the specific surface area is 100 m²/g or less, preferably 90 m²/g or less, more preferably 80 m²/g or less.

The mean primary particle size of the electroconductive fine particles is not specifically defined, but is generally 5 nm or more, preferably 10 nm or more, more preferably 30 nm or more, even more preferably 50 nm or more, while on the other hand, it is generally 100 nm or less, preferably 80 nm or less.

The content of the electroconductive fine particles is not specifically defined so far as it fall within a range not detracting from the advantageous effects of the invention, and the lower limit thereof is generally 0.01 parts by mass or less relative to 100 parts by mass of the toner particles, preferably 0.05 parts by mass or more, more preferably 0.1 parts by mass or more, while on the other hand, the upper limit thereof is generally 10 parts by mass or less, preferably 5 parts by mass, more preferably 1 part by mass.

The resistance of the electroconductive fine particles usable in the invention may be measured according to the method mentioned below. In an environment at 25° C. and 60% RH, 5 g of a sample substance to be analyzed is put into a cylindrical measurement cell having an inner diameter of 2 cm, and while the sample substance is kept sandwiched between two electrodes each having an electrode area of 3.14 cm², the cell is kept stood in the direction of gravitational force, and in that condition, while a weight of 1 kg is kept applied onto the top of the upper electrode, a direct current voltage of 100 V is applied to the cell and using an insulation resistance tester, the resistance value of the sample substance is measured and converted into the volume-specific resistance thereof.

[4. Other External Additives than 1 to 3]

In the invention, if desired, any known fine particles may be used as other external additives in addition to the external additives shown in the above 1 to 3. As the additional fine particles, there are concretely mentioned various inorganic or organic fine particles.

The inorganic fine particles include various carbides such as silicon carbide, boron carbide, titanium carbide, zirconium carbide, hafnium carbide, vanadium carbide, tantalum carbide, niobium carbide, tungsten carbide, chromium carbide, molybdenum carbide, calcium carbide, etc.; various nitrides such as boron nitride, titanium nitride, zirconium nitride, etc.; various borides such as zirconium boride, etc.; various oxides such as calcium oxide, magnesium oxide, zinc oxide, copper oxide, aluminium oxide, cerium oxide, silica, colloidal silica, etc.; various titanate compounds such as calcium titanate, magnesium titanate, strontium titanate, etc.; phosphate compounds such as calcium phosphate, etc.; sulfides such as molybdenum sulfide, etc.; fluorides such as magnesium fluoride, carbon fluoride, etc.; various metal soaps such as aluminium stearate, calcium stearate, zinc stearate, magnesium stearate, etc.; talck, bentonite, various types of carbon black and electroconductive carbon black, magnetite, ferrite, etc.

The organic fine particles include fine particles of styrenic resin, acrylic resin, epoxy resin, melamine resin, etc.

### <Method for Producing Toner Particles>

There is no specific limitation in obtaining the toner particles for use in the invention. Of the above-mentioned production methods, preferred is the melt-kneading grinding method from the viewpoint of colorant dispersibility.

For producing the toner matrix particles for use in the invention according to the melt-kneading grinding method, the above-mentioned binder resin and colorant and optionally any other components are metered each in a predetermined amount, combined and mixed. As examples of the mixing apparatus, there are mentioned a double cone mixer, a V-shaped mixer, a drum-type mixer, a super mixer, a Henschel mixer, a Nauter mixer, etc.

Next, the above combined and mixed toner material is melt-kneaded so as to melt the resins therein, and a colorant and other are dispersed therein. In the melt-kneading step, for example, usable is a batch-type kneading machine such as a pressure kneader, a Banbury mixer or the like, or a continuous kneading machine. As the kneading machine, usable is a single-screw or double-screw extruder, and for example, there are mentioned KOBELCO's KTY-type double-screw extruder, Toshiba Machine's TEM-type double-screw extruder, KCK's double-screw extruder, Buss AG's co-kneader, etc. Further, the color resin composition obtained by melt-kneading the toner material is, after melt-kneaded, rolled in a two-roll system or the like and then cooled in the subsequent cooling step of cooling it with water or the like.

The color resin composition thus obtained in the above is thereafter ground in the next grinding step into particles having a desired particle size. First, the composition is roughly ground with a crusher, a hammer mill, a feather mill or the like, and then finely ground with a Kryptron system by Kawasaki Heavy Industries, a super rotor by Nisshin Engineering, etc. Subsequently, if desired, the powder is classified with a sieving machine such as a classifier, for example, an inertial classification system Elbow Jet (by Nittetsu Mining), a centrifugal classification system Turboprex (by Hosokawa Micron) or the like thereby giving toner matrix particles.

### <Step of Adding Polytetrafluoroethylene Fine Particles/External Additive>

The toner of the invention includes a step of adding at least polytetrafluoroethylene fine particles and inorganic fine particles that have been surface-treated with an amino group-containing treating agent, to the surface of the toner matrix particles obtained according to the above-mentioned method or the like. Adding, as referred to in the invention, means that polytetrafluoroethylene fine particles and inorganic fine particles that have been surface-treated with an amino group-containing treating agent are adhered to or firmly anchored on the surface of the toner matrix particles.

The method of adding the above-mentioned polytetrafluoroethylene fine particles and the inorganic fine particles that have been surface-treated with an amino group-containing treating agent to the surface of the toner particles is not specifically defined so far as, according to the method, the polytetrafluoroethylene fine particles and the inorganic fine particles that have been surface-treated with an amino group-containing treating agent can be adhered to the surface of the toner particles; and for example, there may be employed any known method of mixing the system with a Henschel mixer, a micro-speed mixer, a super mixer or the like.

In case where electroconductive fine particles or any other fine particles than the external additives of the above 1 to 3 are added to toner, these may be mixed along with polytetrafluoroethylene fine particles and an amino group-containing treating agent, or may be mixed in a different step of adding them to toner.

In the invention, in case where the above-mentioned multiple types of external additives are added, they may be mixed all at a time or may be mixed in multiple step of separately adding them. In case where the additives are added in multiple steps, it is desirable that the external additive having a larger mean primary particle size is added in the first adding step, and the external additive having a smaller mean primary particle size is added in the final adding step.

### EXAMPLES

The invention is described more concretely with reference to the following Examples; however, not overstepping the spirit and the scope thereof, the invention is not limited to the following Examples. In the following Examples, “part” is “part by weight”.

### <Printing Evaluation>

As the test apparatus, used here was a commercially-available, nonmagnetic mono-component development system printer “HL-2140”.

The printer was installed in an atmosphere at a temperature of 23° C. and a relative humidity of 50%, and loaded with 100 g of toner, with which 2,000 copies were printed continuously each in a printing ratio of 5%.

In the print test, used was standard paper (lightness 92, paper thickness 20 lb, size letter).

### <Image Density Evaluation>

The image density of the print was measured with a Macbeth densitometer RD914 by Macbeth. At the initial printing and at the printing after 2000 copies, the image density was measured with the Macbeth densitometer. The sample having a print density of less than 1.2 was determined as bad (×), those having a print density of 1.2 or more and less than 1.4 was determined as average (Δ), and those having a print density of 1.4 or more was determined as good (◯).

<Back ground Evaluation>

Back ground on the print was determined as follows: Before and after printing, the whiteness of the standard paper was measured with Nippon Denshoku's SE-6000 (standard light/view angle: C/2, equipped with UV cut filter 420 nm), and the difference therebetween was calculated to be the back ground. The back ground is an average of three copies. At the initial printing and at the printing after 2000 copies, the sample having a back ground of less than 1.5 was determined as good (◯), the sample having a back ground of 1.5 or more and less than 2.2 was determined as average (Δ), and the sample having a back ground of 2.2 or more was determined as bad (×).

### <Solid Printing Conformability Evaluation>

At the initial printing and at the printing after 2000 copies, the image pattern having a printing ratio of 100% on the printed surface was analyzed for the toner toner starvation on black page. The sample in which the entire surface was tightly covered with the toner and in which there was seen no image density difference between the fore-end of the paper and the rear-end thereof in the printing direction was determined as good (◯), the sample in which the fore-end of the paper was covered with toner but the image density was somewhat low in the rear-end thereof and in which, therefore, there appeared visually but by a neck the image density difference between the fore-end and the rear-end of the paper was determined as average (Δ), and the sample in which the image density difference between the fore-end and the rear-end of the paper was visually obvious was determined as bad (×).

### <Toner Scattering Inside the Machine Evaluation>

After the printing resistance test of further 2000 copies, the toner having flown in the cartridge was visually investigated. When the toner flies more in the cartridge, then the photoreceptor, the developing sleeve, the control blade and others are stained with the toner, and the toner would remain in the area below the developing sleeve where the toner should not remain in nature, therefore causing image defects. The case where no toner scattering inside the machine was seen inside the cartridge was determined as good (◯), the case where a little toner scattering inside the machine was seen but no image failure owing to the toner scattering inside the machine was recognized on the print was determined as average (Δ), and the case where toner scattering inside the machine was seen and image failure owing to the toner scattering inside the machine was recognized was determined as bad (×).

### <Method for Measuring Physical Properties of Binder Resin>

The THF soluble component in the binder resin was analyzed for the weight-average molecular weight, the number-average molecular weight and the gel fraction content (% by mass) through gel permeation chromatography (GPC) under the condition mentioned below.

Apparatus: Tosoh's GPC apparatus, HLC-8020,

Column: Polymer Laboratory's PL-gel Mixed-B 10μ,

Solvent: THF,

Sample Concentration: 0.1% by mass,

Calibration Curve: standard polystyrene.

In the following Examples 1 to 3 and Comparative Examples 1 to 3, hydrophobic silica is one embodiment of inorganic fine particles that have been surface-treated with an amino group-containing treating agent.

### Example 1

A positively chargeable nonmagnetic mono-component toner was produced according to the blend ratio mentioned below.

| | | |
|---|---|---|
| Styrene-acrylic resin | 100 | parts |
| (weight-average molecular weight: 14,000, number-average | | |
| molecular weight: 105,000, gel fraction: 33% by mass, | | |
| softening point temperature: 153° C., glass transition | | |
| point temperature: 60° C., acid value: 12 mg/g KOH, main | | |
| components: styrene/butyl acrylate) | | |
| Charge control agent (Orient Chemical Industry's N04) | 1 | part |
| Carbon black (Cabot's Monarch 280) | 6 | parts |
| Polypropylene wax (Sanyo Chemical Industry's 660P) | 3 | parts |

The above materials were mixed with a high-speed mixer, then melt-kneaded in a double-screw extruder, roughly mixed with a hammer mill, finely ground with a mechanical grinder, and then classified to produce toner particles having a volume-average particle size of 9 μm.

According to the blend ratio mentioned below, external additives were mixed with a high-speed mixer to prepare a developer.

| | |
|---|---|
| Toner particles | 100 parts |
| Hydrophobic silica A (Cabot's TF820F, | 0.5 parts |
| mean primary particle size: 8 nm) | |
| Polytetrafluoroethylene fine particles | 0.2 parts |
| (Shamrock's Fluoro A) | |

### Comparative Example 1

According to the blend ratio mentioned below, a positively chargeable nonmagnetic mono-component toner was produced.

| | |
|---|---|
| Styrene-acrylic resin | 100 parts |
| (weight-average molecular weight: 14,000, number-average | |
| molecular weight: 105,000, gel fraction: 33% by mass, | |
| softening point temperature: 153° C., glass transition | |
| point temperature: 60° C., acid value: 12 mg/g KOH, main | |
| components: styrene/buryl acrylate) | |
| Charge control agent (Orient Chemical Industry's N04) | 2 parts |
| Carbon black (Cabot's Monarch 280) | 6 parts |
| Polypropylene wax (Sanyo Chemical Industry's 660P) | 3 parts |

The above materials were mixed with a high-speed mixer, then melt-kneaded in a double-screw extruder, roughly mixed with a hammer mill, finely ground with a mechanical grinder, and then classified to produce toner particles having a volume-average particle size of 9 μm.

According to the blend ratio mentioned below, external additives were mixed with a high-speed mixer to prepare a developer.

| | |
|---|---|
| Toner particles | 100 parts |
| Hydrophobic silica A (Cabot's TG820F, | 0.5 parts |
| mean primary particle size: 8 nm) | |

### Comparative Example 2

According to the blend ratio mentioned below, a positively chargeable nonmagnetic mono-component toner was produced.

| | |
|---|---|
| Styrene-acrylic resin | 100 parts |
| (weight-average molecular weight: 14,000, number-average | |
| molecular weight: 105,000, gel fraction: 33% by mass, | |
| softening point temperature: 153° C., glass transition | |
| point temperature: 60° C., acid value: 12 mg/g KOH, main | |
| components: styrene/butyl acrylate) | |
| Charge control agent (Orient Chemical Industry's N04) | 2 parts |
| Carbon black (Cabot's Mogul L) | 6 parts |
| Polypropylene wax (Sanyo Chemical Industry's 660P) | 3 parts |

The above materials were mixed with a high-speed mixer, then melt-kneaded in a double-screw extruder, roughly mixed with a hammer mill, finely ground with a mechanical grinder, and then classified to produce toner particles having a volume-average particle size of 9 μm.

According to the blend ratio mentioned below, external additives were mixed with a high-speed mixer to prepare a developer.

| | |
|---|---|
| Toner particles | 100 parts |
| Hydrophobic silica A (Cabot's TG820F, | 0.5 parts |
| mean primary particle size: 8 nm) | |

### Example 2

According to the blend ratio mentioned below, a positively chargeable nonmagnetic mono-component toner was produced.

| | | |
|---|---|---|
| Styrene-acrylic resin | 100 | parts |
| (weight-average molecular weight: 14,000, number-average | | |
| molecular weight: 105,000, gel fraction: 33% by mass, | | |
| softening point temperature: 153° C., glass transition | | |
| point temperature: 60° C., acid value: 12 mg/g KOH, | | |
| main components: styrene/butyl acrylate) | | |
| Charge control agent (Orient Chemical Industry's N04) | 1 | part |
| Carbon black (Cabot's Vulcan XC72) | 9 | parts |
| Polypropylene wax (Sanyo Chemical Industry's 660P) | 4 | parts |

The above materials were mixed with a high-speed mixer, then melt-kneaded in a double-screw extruder, roughly mixed with a hammer mill, finely ground with a mechanical grinder, and then classified to produce toner particles having a volume-average particle size of 9 μm.

According to the blend ratio mentioned below, external additives were mixed with a high-speed mixer to prepare a developer.

| | |
|---|---|
| Toner particles | 100 parts |
| Hydrophobic silica A (Wacker's HDK H13TA, | 0.3 parts |
| mean primary particle size: 20 nm) | |
| Hydrophobic silica C (Tayca's MSP-11, | 0.3 parts |
| mean primary particle size: 30 nm) | |
| Polytetrafluoroethylene fine particles | 0.4 parts |
| (Shamrock's Fluoro A) | |

### Example 3

According to the blend ratio mentioned below, a positively chargeable nonmagnetic mono-component toner was produced.

| | | |
|---|---|---|
| Styrene-acrylic resin | 100 | parts |
| (weight-average molecular weight: 14,000, number-average | | |
| molecular weight: 105,000, gel fraction: 33% by mass, | | |
| softening point temperature: 153° C., glass transition | | |
| point temperature: 60° C., acid value: 12 mg/g KOH, main | | |
| components: styrene/butyl acrylate) | | |
| Charge control agent (Orient Chemical Industry's N04) | 1 | part |
| Carbon black (Cabot's Vulcan XC72) | 9 | parts |
| Polypropylene wax (Sanyo Chemical Industry's 660P) | 4 | parts |

The above materials were mixed with a high-speed mixer, then melt-kneaded in a double-screw extruder, roughly mixed with a hammer mill, finely ground with a mechanical grinder, and then classified to produce toner particles having a volume-average particle size of 9 μm.

According to the blend ratio mentioned below, external additives were mixed with a high-speed mixer to prepare a developer.

| | |
|---|---|
| Toner particles | 100 parts |
| Hydrophobic silica A (Wacker's HDK H13TA, | 0.6 parts |
| mean primary particle size: 20 nm) | |
| Hydrophobic silica B (Cabot's TG820F, | 0.3 parts |
| mean primary particle size: 8 nm) | |
| Polytetrafluoroethylene fine particles | 0.6 parts |
| (Shamrock's Fluoro A) | |
| Electroconductive titanium oxide (mean | |
| primary particle size: 50 to 80 nm, BET | |
| specific surface area: 40 to 60 m²/g, | |
| resistance: 20 to 500 Ω · cm) | |

### Comparative Example 3

According to the blend ratio mentioned below, a positively chargeable nonmagnetic mono-component toner was produced.

| | | |
|---|---|---|
| Polyester resin | 100 | parts |
| (weight-average molecular weight: 4,400, number-average | | |
| molecular weight: 27,400, gel fraction: 31% by mass, | | |
| softening point temperature: 133° C., glass transition | | |
| point temperature: 60° C., acid value: 28 mg/g KOH, main | | |
| components: terephthalic acid/bisphenol A ethylene oxide | | |
| adduct/bisphenol A propylene oxide adduct) | | |
| Charge control agent (Orient Chemical Industry's N04) | 1 | part |
| Carbon black (Cabot's Vulcan XC72) | 9 | parts |
| Polypropylene wax (Sanyo Chemical Industry's 660P) | 4 | parts |

The above materials were mixed with a high-speed mixer, then melt-kneaded in a double-screw extruder, roughly mixed with a hammer mill, finely ground with a mechanical grinder, and then classified to produce toner particles having a volume-average particle size of 9 μm.

According to the blend ratio mentioned below, external additives were mixed with a high-speed mixer to prepare a developer.

| | |
|---|---|
| Toner particles | 100 parts |
| Hydrophobic silica A (Wacker's HDK H13TA, | 0.6 parts |
| mean primary particle size: 20 nm) | |
| Hydrophobic silica B (Cabot's TG820F, | 0.3 parts |
| mean primary particle size: 8 nm) | |
| Polytetrafluoroethylene fine particles | 0.6 parts |
| (Shamrock's Fluoro A) | |
| Electroconductive titanium oxide (mean | |
| primary particle size: 50 to 80 nm, BET | |
| specific surface area: 40 to 60 m²/g, | |
| resistance: 20 to 50 Ω · cm) | |

The toners produced in Examples 1 to 3 and Comparative Examples 1 to 3 were tested in point of the following evaluation items, and the results are shown in Table 1. In addition, the physical properties of the carbon blacks used in Examples 1 to 3 and Comparative Examples 1 to 3 are shown in Table 2.

TABLE 1

| | | | Comparative | Comparative | | | Comparative |
|---|---|---|---|---|---|---|---|
| | | Example 1 | Example 1 | Example 2 | Example 2 | Example 3 | Example 3 |
| Toner Particles | | | | | | | |
| Resin | styrene-acrylic | 100 | 100 | 100 | 100 | 100 | |
| | polyester | | | | | | 100 |
| Colorant | XC72 | | | | 9 | 9 | 9 |
| | Monarch 280 | 6 | 6 | | | | |
| | Mogul L | | | 6 | | | |
| Wax | 660P | 3 | 3 | 3 | 4 | 4 | 4 |
| Charge Control Agent | N04 | 1 | 2 | 2 | 1 | 1 | 1 |
| External Additives | | | | | | | |
| PDFE | Fluoro A | 0.2 | | | 0.4 | 0.6 | 0.6 |
| Electroconductive Particles | electroconductive TiO₂ | | | | | 0.3 | 0.3 |
| Amino-Modified Inorganic | H13TA | | | | | 0.6 | 0.6 |
| Fine Particles | TG820F | 0.5 | 0.5 | 0.5 | 0.3 | 0.3 | 0.3 |
| | MSP-11 | | | | 0.3 | | |
| Evaluation Results | | | | | | | |
| Image Density | initial | ∘ 1.41 | ∘ 1.45 | ∘ 1.18 | ∘ 1.52 | ∘ 1.56 | x 0.35 |
| | 2000 copies | Δ 1.37 | Δ 1.35 | Δ 1.39 | ∘ 1.45 | ∘ 1.46 | |
| Back ground | initial | ∘ 1.20 | x 3.35 | x 3.92 | Δ 1.41 | ∘ 0.91 | x 9.37 |
| | 2000 copies | ∘ 0.85 | Δ 1.32 | ∘ 1.40 | ∘ 1.07 | ∘ 1.81 | |
| Solid Printing | 2000 copies | Δ | x | x | Δ | ∘ | x |
| Conformability | | | | | | | |
| Toner scattering inside the | 2000 copies | Δ | x | x | Δ | ∘ | |
| machine | | | | | | | |

In Table 1, PDFE represents polytetrafluoroethylene fine particles, and amino-modified inorganic fine particles are inorganic fine particles that have been surface-treated with an amino group-containing treating agent.

TABLE 2

| | Mean Primary | DBP Oil Absorption | BET |
|---|---|---|---|
| | Particle Size nm | cc/100 g | cm³/g |
| XC72 | 30 | 174 | 254 |
| Monarch 289 | 45 | 121 | 42 |
| Mogul L | 24 | 60 | 138 |

From the above Table 1, it is known that Examples 1 to 3 falling within the scope of the invention well attain good image density and toner starvation on black page and well prevent back ground and toner scattering inside the machine both at the initial printing and at the printing after 2000 copies, as compared with Comparative Examples 1 and 2 not using polytetrafluoroethylene fine particles and Comparative Example 3 not using a styrene-acrylic resin. In Comparative Example 3 using a polyester resin but not using a styrene-acrylic resin, the initial image was extremely bad relative to the test items of image density reduction, back ground and solid printing conformability, and therefore the print test got cancelled.

While the present invention has been described in detail and with reference to specific embodiments thereof, it will be apparent to one skilled in the art that various changes and modifications can be made therein without departing from the spirit and scope thereof. This application is based upon a Japanese patent application filed on Dec. 26, 2011 (Patent Application 2011-283696), and the contents thereof are incorporated herein by reference.

1. A positively chargeable toner for nonmagnetic mono-component development system, which at least comprises a binder resin, a colorant and a charge control agent wherein the binder resin is a styrene-acrylic resin, and the toner at least comprises: polytetrafluoroethylene fine particles: and inorganic fine particles that have been surface-treated with an amino group-containing treating agent.

2. The positively chargeable toner for nonmagnetic mono-component development system according to claim 1, wherein the colorant is carbon black satisfying the following (1) and (2):
(1) The mean primary particle size is from 20 nm to 50 nm,
(2) The DBP oil absorption is from 100 cc/100 g to 200 cc/100 g.

3. The positively chargeable toner for nonmagnetic mono-component development system according to claim 1, which comprises electroconductive fine particles having a resistance of from 1 Ω·cm or more to 100 Ω·cm or less.

4. The positively chargeable toner for nonmagnetic mono-component development system according to claim 3, wherein the electromagnetic fine particles are an electroconductive titanium oxide.

5. The positively chargeable toner for nonmagnetic mono-component development system according to claim 1, wherein the inorganic fine particles that have been surface-treated with an amino group-containing treating agent contain inorganic fine particles A that have been surface-treated with an amino group-containing treating agent and inorganic fine particles B that have been surface-treated with an amino group-containing treating agent, and the inorganic fine particles satisfy the following formula (I):
aᵣ/bᵣ<1 Formula (I)
(In the above formula (I), aᵣ (nm) represents the mean primary particle size (nm) of the inorganic fine particles A that have been surface-treated with an amino group-containing treating agent; and bᵣ (nm) represents the mean primary particle size (nm) of the inorganic fine particles B that have been surface-treated with an amino group-containing treating agent.)

6. The positively chargeable toner for nonmagnetic mono-component development systems according to claim 5, wherein the inorganic fine particles that have been surface-treated with an amino group-containing treating agent contain inorganic fine particles A that have been surface-treated with an amino group-containing treating agent and inorganic fine particles B that have been surface-treated with an amino group-containing treating agent, and the inorganic fine particles satisfy the following formula (II):
aₘ/bₘ≦1 Formula (II)
(In the above formula (II), aₘ (part by mass) represents the amount of the inorganic fine particles A that have been surface-treated with an amino group-containing treating agent in terms of part by mass relative to 100 parts by mass of the toner particles; and bₘ (part by mass) represents the amount of the inorganic fine particles B that have been surface-treated with an amino group-containing treating agent in terms of part by mass relative to 100 parts by mass of the toner particles.)
